(19) United States
(12) Patent Application Publication
(10) Pub. No.: US 2009/0165929 A1
(43) Pub. Date: Jul. 2, 2009

(54) Process and apparatus for manufacturing a pneumatic tyre

(76) Inventor: Maurizio Marchini, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/227,699

(22) PCT Filed: May 31, 2006
(86) PCT No.: PCT/IT2006/000411

§ 371 Date: Nov. 25, 2008

(51) Int. Cl. B29D 30/18; B29D 30/08

(52) U.S. Cl. 156/117; 156/402

(57) ABSTRACT

A process and an apparatus for building a pneumatic tyre for vehicle wheels, in which the tyre includes a carcass structure including at least one carcass ply, at least one annular reinforcing structure associated with the carcass structure, a tread band at a position radially external to the carcass structure, and a pair of sidewalls at axially opposite positions on the carcass structure. The apparatus has a toroidal support and at least one turning-up device provided with an annularly continuous presser element axially translatable along the axis of the toroidal support and radially expandable and contractible relative to the axis of the toroidal support to contact the axially internal surfaces of the strip-like elements and turn them up around at least one reinforcing element.

The present invention relates to a method of building a pneumatic tyre and to an apparatus for putting this method into practice.

Generally, a tyre for vehicle wheels has a carcass structure essentially made up of one or more carcass plies substantially having a toroidal conformation. The axially opposite side edges of these plies are engaged to respective annular reinforcing structures.

Each annular reinforcing structure is incorporated into a so-called “bead” defined along an inner circumferential edge of the tyre for anchoring of the latter to a corresponding mounting rim.

In addition, generally associated with the carcass structure is a belt structure comprising one or more layers disposed in radial superposed relationship with respect to each other and to the carcass ply.

The belt layers generally consist of textile or metallic reinforcing cords with a crossed orientation and/or substantially parallel to the circumferential extension direction of the tyre. Applied to the belt structure at a radially external position is a tread band, made of elastomeric material like the other semifinished products constituting the tyre.

To the aims of the present description, by the term “elastomeric material” it is intended a composition comprising at least one elastomeric polymer and at least one reinforcing filler, and possibly additives of various types (cross-linking agents, plasticizers and other additives known in the art, for example).

Finally, a pair of sidewalls is provided on the axially opposite sides of the tyre, each sidewall coating a side portion of the tyre included between a so-called shoulder region, located close to the corresponding side edge of the tread band, and the corresponding bead.

In traditional manufacturing processes, formation of the carcass ply is carried out by means of a rubberised fabric comprising a plurality of reinforcing thread elements, parallel to each other and incorporated into a layer of elastomeric material, in the following referred to as “cords”. Said rubberised fabric is for example made through a calendering operation sandwiching a plurality of said cords, disposed coplanar in side by side relationship, between two layers of elastomeric material.

The threads of said cords can consist of metal alloys such as steel, textile fibres, carbon fibres, glass fibres, Kevlar® or other fibres having a suitable strength for use in tyre construction.

Each carcass ply is then assembled to the other tyre components such as the so-called bead cores, on a cylindrical building drum. The carcass ply is turned up around said bead cores in such a manner that when the whole carcass structure, initially made in the form of a cylindrical sleeve, is shaped into a toroidal configuration, the carcass ply and bead cores remain associated with each other, with the carcass ply turned up around said bead cores, being extended from the inside to the outside both axially and radially.

In a subsequent operation other tyre components, such as the belt structure, sidewalls and tread band, are then assembled onto the carcass structure.

In traditional production processes, i.e. with the carcass ply of one piece construction disposed on the building drum, there are different devices for turning the ply up.

For instance U.S. Pat. No. 6,318,434 discloses a tyre building drum with a turning-up device for a carcass ply of one piece construction in which the drum has two annular segments spaced apart from each other to bear a bead core, and drum segments disposed inside each annular segment for the purpose of supporting the tyre components. Said building drum has means for radially expanding that part of the tyre components supported by said inner drum segments.

In addition, the drum on both sides external to the annular segments has a first and a second set of axially extensible arms. Each arm has one end provided with a roller, and means for axially and radially moving each set of arms from a first position at which the rollers of one set form a virtually closed loop and a second radially expanded position at which, during the turning-up operation, pressing of the expanded part of the tyre components that is located externally of the annular segments is carried out. Each roller of an arm of the second set is placed between two adjacent arms of the first set. In an expanded position, the rollers of each set are mutually spaced and positioned to a given distance relative to the rollers of the remaining set.

U.S. Pat. No. 4,362,592 discloses a ply turning-up device for use with a building drum. The turning-up device comprises a plurality of arms disposed so as to form a circumference concentric to the axis of the building drum. The arms can be extended radially outwardly and have a radially movable free end to support through a suitable supporting element, a ring-shaped rotatable and expandable element embodied by a helical spring.

U.S. Pat. No. 3,887,423 discloses a machine for tyre building using a device for turning up the carcass ply, which device is laterally disposed at each end of the building drum.

The mechanism comprises a plurality of rotatably mounted arms and an extensible annular air bag provided on said arms. Said arms rotate to cause turning up of the carcass ply and are axially movable to close the carcass ply upon itself when turned up. The outer end of each arm is provided with rollers suitable for engagement with the inside of the air bag.

In accordance with recent production processes, as disclosed in document EP 928 680 in the name of the same Applicant for example, a tyre can be directly built on a toroidal support. A first carcass ply is formed by laying on said toroidal support, “strip-like elements” each comprising longitudinal thread elements incorporated into a layer of elastomeric material. Said strip-like elements are sequentially laid so as to form a carcass structure. Annular reinforcing structures are associated with the carcass ply and they for example comprise a first and a second circumferential annular inserts and an elastomeric filler at least partly interposed therebetween. A second carcass ply can be formed in superposed relationship with the first carcass ply and with said annular structures. A belt structure also made through laying of strip-like elements is then associated with the carcass structure thus formed. Subsequently, a tread band and a pair of sidewalls are built thereon, through application of a basic semifinished product of elastomeric material consisting of an elongated element of suitable sizes, so as to form coils disposed in axial side by side relationship with respect to each other, and/or in radial superposition. This process therefore contemplates use of at least two different types of basic semifinished products, and exactly: the elongated element, i.e. a section member made of elastomeric material alone, of a substantially rectangular section; the strip-like element, i.e. a strip of elastomeric material into which reinforcing thread elements are incorporated, typically textile or metallic cords. The strip-like element thus made contains a certain number of cords per centimetre of its cross section, and said number identifies the “density” of the cords.

It is to be noted that the tyre made in accordance with the above description has a carcass structure associated with the annular reinforcing structures, but not turned up with respect to said structures.

However, to satisfy the requirement of a carcass structure more strongly fastened to the annular reinforcing structures some different solutions have been proposed.

In particular, document WO 2004/0910939 in the name of the same Applicant discloses a pneumatic tyre for vehicle wheels and a method of manufacturing it, in which the carcass structure has at least one carcass ply, at least one annular reinforcing structure associated with the carcass structure, a tread band at a position radially external to the carcass structure and a pair of sidewalls at axially opposite positions on the carcass structure. Each carcass ply has a plurality of strip-like elements.

The strip-like elements are disposed in a substantially U-shaped conformation around the cross-section outline of the tyre in such a manner as to show two side portions spaced apart from each other in an axial direction, and a crown portion extending between said side portions at a radially external position.

WO2004/0910939 however does not teach how the step of turning up the strip-like elements around the annular reinforcing structures is to be carried out, and which means are to be used for this purpose.

The Applicant has first of all noticed that for industrialisation of a process for manufacturing tyre structures according to the above mentioned document, turning up of all the strip-like elements around the annular reinforcing structures is required to be made simultaneously.

The Applicant has further found that during the turning-up step it is necessary to exert an evenly distributed pressure on all the strip-like elements to be turned up, so as to obtain a regular and compact structure.

In addition, the Applicant has also noticed that for this turning-up operation a device is required that is able to make the strip-like elements follow, during turning-up, the complex outline of the toroidal support.

A further requirement of which the Applicant has become aware is the necessity to provide a flexible process and apparatus in terms of fitting variability (size of the tyre), which can be directly obtained in line with the same apparatus.

The Applicant has found that the above mentioned production requirements can be met by a process and an apparatus as described in the following.

It is to be pointed out that a strip-like element is intended herein and in the following, as “turned up” around an annular reinforcing structure or a bead core in the bead region, if at least one straight line parallel to the straight line tangent to the radially outermost point of the tyre section identified by the lying plane of the strip-like element crosses the outline of the strip-like element in the bead region at least at two distinct points.

In the case of a radial tyre, the lying plane of the strip-like element is substantially coincident with a cross section of the tyre and the straight line tangent to the radially outermost point of the cross section is parallel to the rotation axis of the tyre itself.

By “bead region” it is intended, as previously illustrated, the axially internal circumferential region of the tyre designed for anchoring of the tyre itself to a mounting rim, each bead region internally comprising said annular reinforcing structure.

In a first aspect, the invention relates to a process for building a pneumatic tyre comprising: a carcass structure including at least one carcass ply; at least one annular reinforcing structure associated with the carcass structure at a radially internal edge of the carcass structure; a tread band at a radially external position to said carcass structure; and a pair of sidewalls located at axially opposite positions on the carcass structure; the process comprising the steps of:

a) laying a plurality of strip-like elements onto a toroidal support, each strip-like element comprising at least one reinforcing element coated with at least one layer of elastomeric material and being laid in a substantially U-shaped conformation around the cross-section outline of the toroidal support to define a crown portion extending on said toroidal support at a radially external position and two side portions spaced apart from each other in an axial direction, the side portions of at least one strip-like element comprising end portions radially projecting towards the central axis (X-X′) of said toroidal support;
b) applying said at least one annular reinforcing structure close to said side portions, each at a position radially more external than said end portions;
c) bringing an annularly continuous presser element into contact with the axially internal surfaces of the end portions;
d) axially and radially translating said annularly continuous presser element to fold said end portions around said at least one annular reinforcing structure.

By exerting pressure in a continuous and uniform manner, circumferentially on all the strip-like elements to be turned up, the drawbacks found in the past in the tyre and in recent manufacturing processes with basic semifinished products (elongated element, strip-like element) can be overcome and, in addition, since the circumferential sizes of the elements exerting pressure on the strip-like elements can be freely varied, tyres adapted for different sizes of the rim can also be manufactured using the same apparatus directly in line, which will increase the flexibility of the production process.

In a preferential aspect of the present invention, step a) is repeated until a carcass ply has been completed.

In another preferential aspect step a) is repeated until completion of two superposed carcass plies.

In a further aspect the invention relates to an apparatus for building a pneumatic tyre, comprising a toroidal support; at least one device for laying a plurality of strip-like elements onto said toroidal support; devices for applying at least one annular reinforcing structure close to an inner radial edge of said toroidal support and at least one turning-up device including an annularly continuous presser element in coaxial relation with the central axis X-X′ of the toroidal support and radially expandable relative to said central axis X-X′ of the toroidal support to contact the axially internal surfaces of the strip-like elements and turn them up around said at least one annular reinforcing structure.

In a preferential aspect, the annularly continuous presser element comprises a plurality of contact elements disposed along a circumference that is concentric to the central axis X-X′ of the toroidal support, and a plurality of centres of rotation each operationally associated with a contact element to enable each contact element to rotate relative to the respective centre of rotation to radially expand the presser element between a radially contracted position and a radially expanded position at which said contact elements are disposed close to the side of said toroidal support; each contact element defining a continuous circumferential surface with the adjoining contact elements at the radially expanded position of the presser element.

Preferably, each contact element is circumferentially telescopically slidable relative to the adjoining contact element.

In another preferential aspect, the plurality of contact elements comprises a first set of male rollers including two axially opposite ends and a second set of female rollers including two axially opposite cavities, the male and female rollers being disposed in such a manner that each male roller is followed by a female roller, each end of a male roller being engaged in a cavity of a female roller thereby forming a closed loop.

Preferably, the apparatus comprises a plurality of support levers for the contact elements, which levers are disposed along a circumference that is concentric to the axis of the toroidal support, each lever being hinged on a centre of rotation.

In a further preferential aspect, all centres of rotation of the support levers are supported by a guide that is axially slidable relative to the axis of the toroidal support element.

Advantageously, each lever comprises one end hinged on a second guide element axially translatable relative to the first guide element to determine a radial expansion or contraction of the presser element.

Further features and advantages of the invention will become more apparent from the detailed description of same preferred but not exclusive embodiments of a method of building a pneumatic tyre for vehicle wheels and of an apparatus related to this method, in accordance with the present invention.

This description will be set out hereinafter with reference to the accompanying drawings, given by way of non-limiting example, in which:

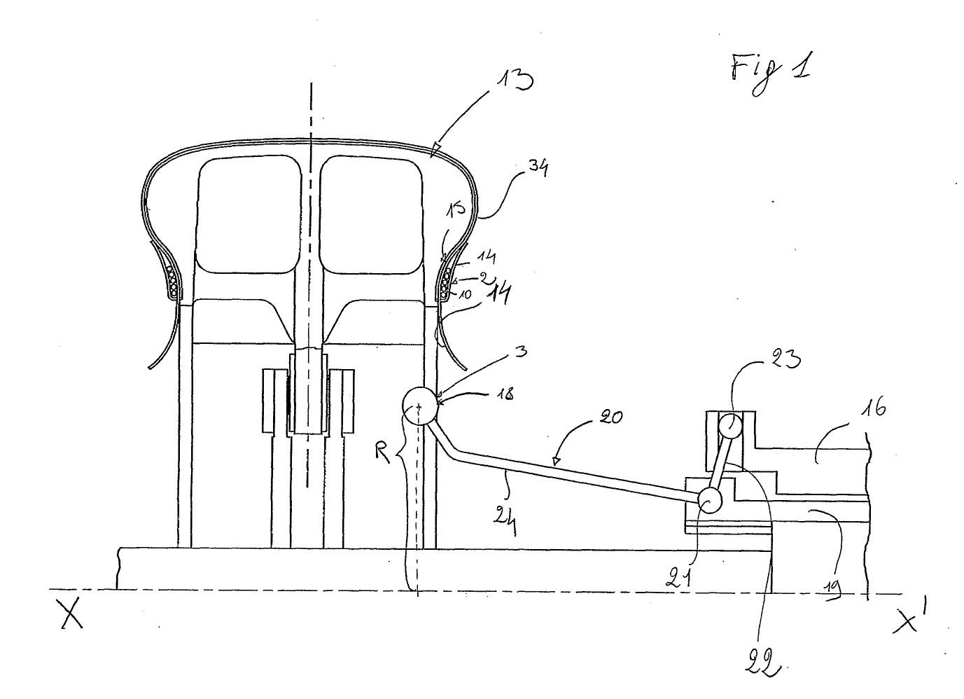

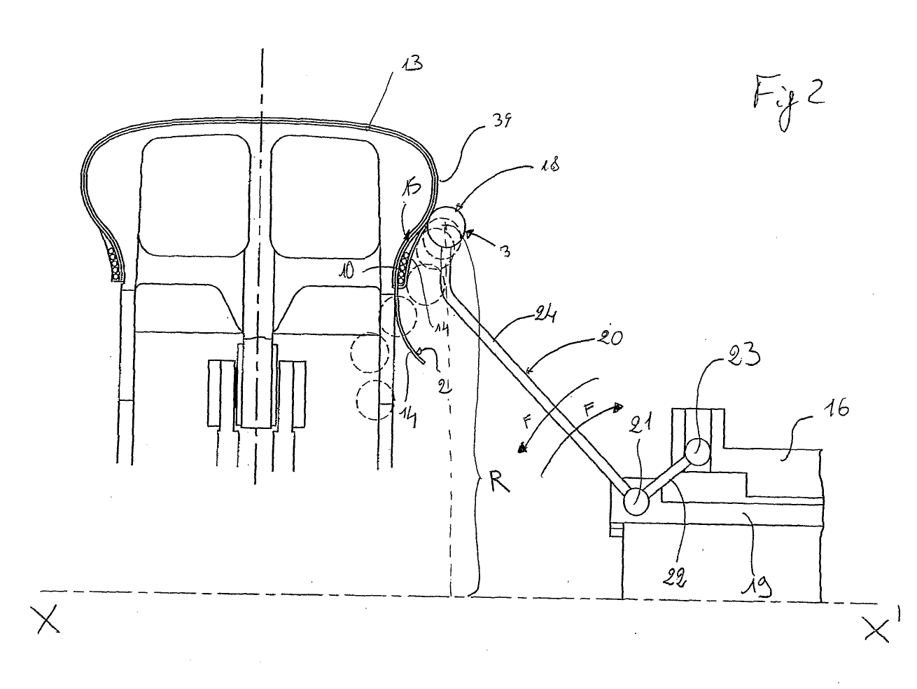

FIG. 1 is a diagrammatic view of an apparatus for building a tyre in accordance with the invention, with a turning-up device in a closed position;

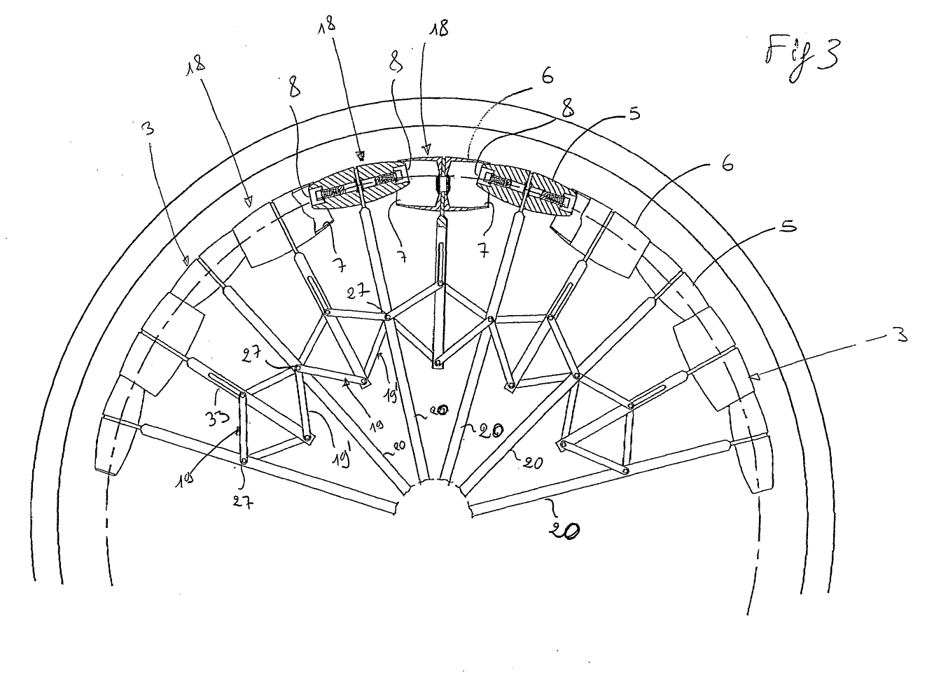

FIG. 2 is a diagrammatic view of an apparatus for building a tyre in accordance with the invention, with a turning-up device in an open position;

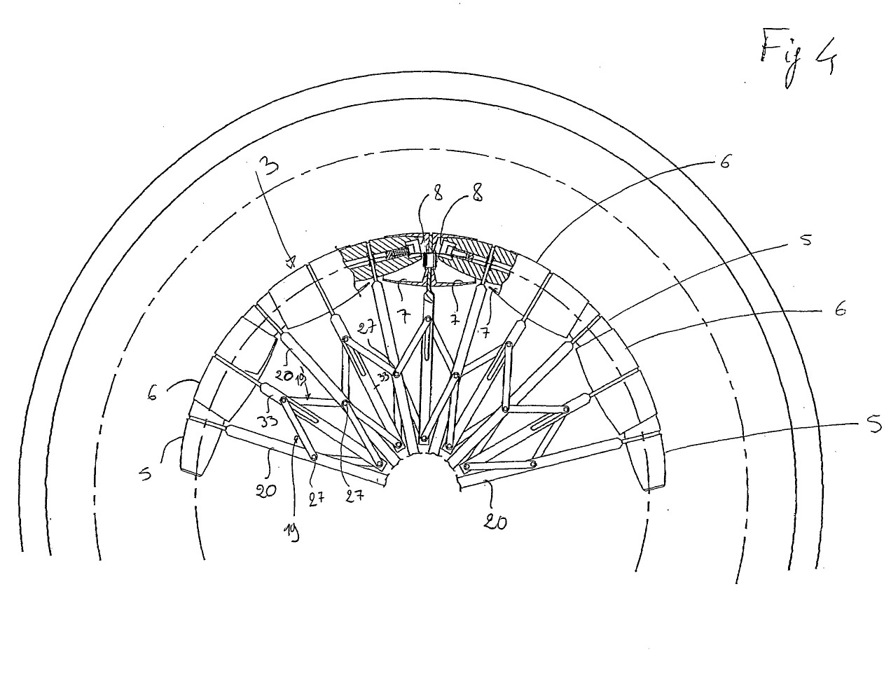

FIG. 3 is a diagrammatic side view of the annular element of a turning-up device in accordance with the present invention, in a contracted configuration;

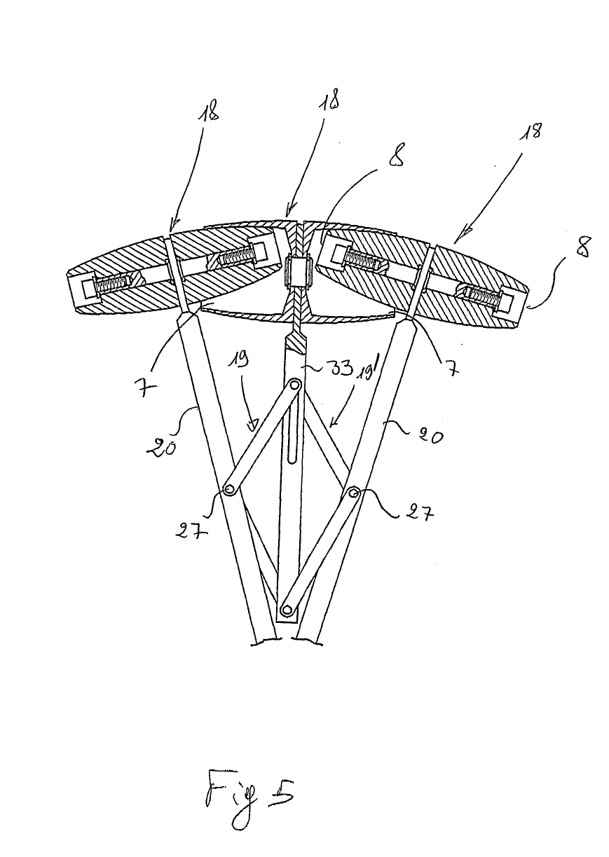

FIG. 4 is a diagrammatic side view of the annular element of the turning-up device according to the present invention in an open-expanded configuration;

FIG. 5 is a diagrammatic view of a detail of a turning-up device in accordance with the present invention;

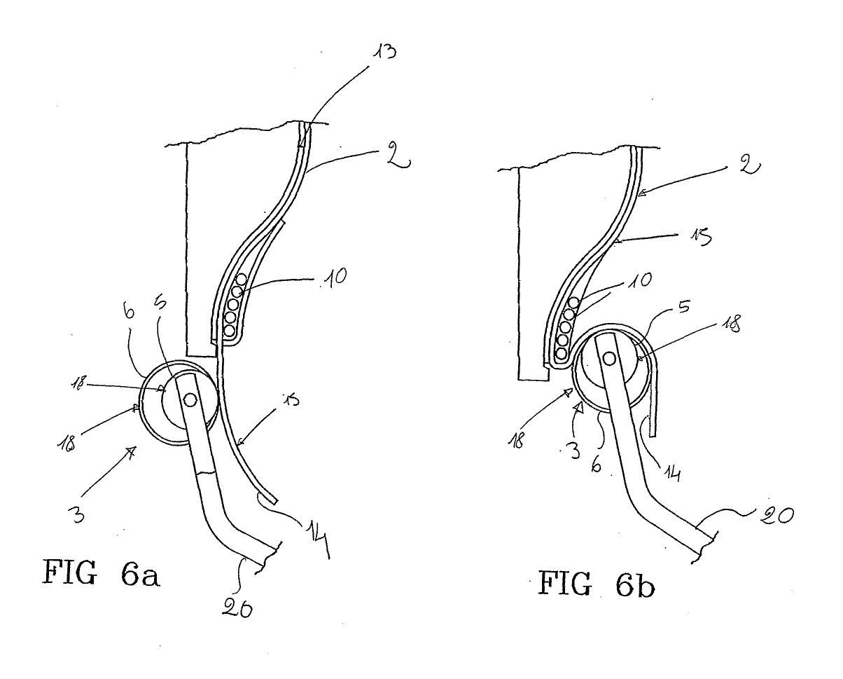

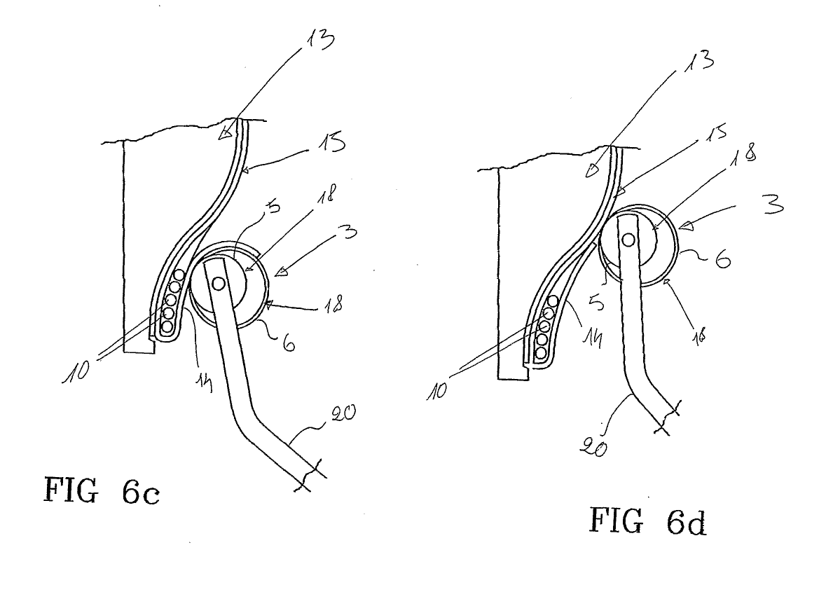

FIGS. 6a-6d are partial side views of some instants in succession of the turning-up step with the method according to the present invention; and

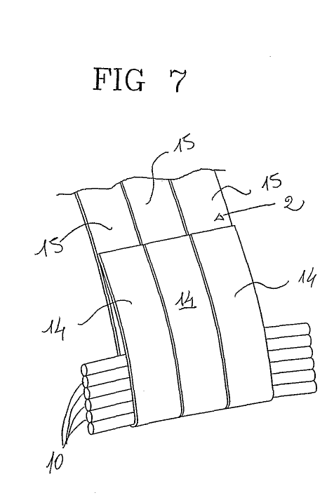

FIG. 7 is a diagrammatic view of a detail of a first embodiment of a carcass structure made following the method in accordance with the present invention.

With reference to FIGS. 1 and 2, an apparatus for building a pneumatic tyre for vehicle wheels in accordance with the present invention is identified with reference numeral 1.

The pneumatic tyre manufactured with the method and apparatus according to the present invention is of the type essentially provided with a carcass structure comprising at least one carcass ply 2 made up of a plurality of strip-like elements 15 including at least one reinforcing element coated with at least one layer of elastomeric material.

Apparatus 1 has a toroidal support 13 on which the strip-like elements 15 forming the carcass ply 2 are disposed, and at least one turning-up device 100 carrying out turning up of said strip-like elements 15 around an annular reinforcing structure.

The apparatus 1 in accordance with the present invention generally has two turning-up devices 100 placed laterally of the toroidal support 13; however, since the turning-up devices 100 are perfectly identical and arranged in a mirror image with respect to the toroidal support 13, only one of them will be described and illustrated in the present specification.

It is also to be noted that in FIGS. 1 and 2 only the upper half of the toroidal support 13 is shown, the lower one that is perfectly symmetrical with respect to axis X-X′ has been omitted for convenience.

Each turning-up device 100 has an annularly continuous presser element 3 that is axially translatable along the axis of the toroidal support 13 and radially expandable or contractible still with respect to the axis X-X′ of the toroidal support 13.

In the present description by annularly continuous presser element it is intended an element in which the constituent parts thereof are such disposed as to always form a closed loop without a break, irrespective of the radial expansion or contraction of same.

In this way it is avoided that during radial expansion of the presser element, gaps may be created that let the strip-like element slip away at least partly so that it is not turned up or it is turned up in a different manner as compared with the remaining strip-like elements of the same ply.

To this aim, the annularly continuous presser element 3 comprises a plurality of contact elements 18 disposed along a circumference that is concentric to the axis of the toroidal support 13 and a plurality of centres of rotation 21 each operationally associated with a contact element 18 to enable each contact element 18 to rotate relative to the respective centre of rotation 21.

In other words, to radially expand or contract the presser element 3, each contact element 18 rotates in a continuous manner, i.e. takes all possible angular positions, around its centre of rotation 21, as shown by arrows F in FIG. 1.

The possibility of the contact elements 18 taking any angular position starting from an angular position that is selected depending on the tyre manufacturing requirements enables several different tyre sizes to be controlled substantially simultaneously on the same production line.

By tyre sizes it is herein and in the following intended the nominal fitting diameter of the rim, generally expressed in inches. In other terms, the contact elements 18 can be located in any contraction position of the annular element 3 depending on the size of the tyre to be manufactured, starting then from that position for carrying out turning up of the strip-like elements forming the carcass ply 2.

As above said, the contact elements 18 are disposed around a circumference that is concentric to axis X-X′ of the toroidal support 13, in this way defining a radius R for the annularly continuous presser element 3, relative to said toroidal support. On radial expansion of the annular element 3 there is a corresponding increase of radius R and on radial contraction of element 3 a reduction of radius R occurs.

In detail, the annularly continuous presser element 3 rotates between a radially contracted position (FIG. 1) that is selected depending on the size of the tyre to be manufactured and an expanded position at which the contact elements 18 are disposed close to the side 34 of the toroidal support 13 (FIG. 2).

Each contact element 18 is always in contact with the adjoining contact elements 18 so as to define a continuous circumferential surface, irrespective of the radial expansion or contraction positions of the same presser element 3.

The contact elements 18 are either directly or indirectly supported, as better specified in the following, by a plurality of support levers 20 disposed along a circumference that is concentric to the axis of the toroidal support 13. Each lever 20, see FIGS. 1 and 2, comprises a main body 24 hinged on a first guide element 19 at the centres of rotation 21 to enable rotation of the contact elements 18 in the direction denoted by arrows F.

In particular, to enable the levers 20 to rotate about the centres of rotation 21, each lever 20 has an end portion 22 inclined to the main body 24 and supported at 23, on a second guide element 16. According to an advantageous aspect of the present invention, the end portion 22 is inclined to the main body 24 through about 90°.

The second guide element 16 is able to axially translate relative to the first guide element 19 and for the purpose it is mounted in coaxial relationship with the first guide element 19.

Axial translation of the second guide element 16 relative to the first guide element 19 causes rotation of levers 20 about the centres of rotation 21 and consequently, depending on the rotation direction, radial expansion or contraction of the presser element 3.

In addition, the axial translation of the second guide element 16 relative to the first guide element 19 determines and allows adjustment of the radial contraction position of the presser element 3. Therefore, the two guide elements 16, 19 together with the particular conformation of the levers 20 act as adjusting means for the contraction position of the annular element 3.

Each support lever 20 has a second end 25, supporting the contact element 18, that is disposed inclined to the main body 24 to enable the contact element 18 to get into contact with the axially internal surface of the strip-like elements 15 forming the carcass ply 2.

To enable axial translation of the contact elements 18 of the annularly continuous presser element 3, the guide element 19 is axially slidable relative to axis X-X′ of the toroidal support element 13.

The translation movement of the contact elements 18 relative to axis X-X′ combined with the rotation of said elements 18 around the centres of rotation 21 allows each contact element 18 to perfectly follow the complex outline of the toroidal support 13 during the step of turning up the strip-like elements 15.

The contact elements 18 are embodied by a first set of male rollers 5 and a second set of female rollers 6 telescopically mounted with respect to each other.

In detail, as shown in FIGS. 3 and 4, each male roller 5 is substantially shaped as a cylinder provided with two axially opposite head ends 8 while each female roller 6 substantially appears like a cylinder which is provided with two axially opposite cavities 7 in register with the head ends of the male rollers 5.

The male 5 and female 6 rollers are therefore disposed, as shown in FIGS. 3 and 4, in such a manner that each male roller 5 is followed by a female roller 6 and that each end 8 of a male roller 5 is engaged in a cavity 7 of a female roller 6 so as to form a closed loop.

According to a first embodiment, not shown in the figures, the male rollers 5 and female rollers 6 are directly supported by the support levers 20. In detail, each male roller 5 and each female roller 6 is rotatably mounted on a respective support lever 20 so that it can rotate about its symmetry axis.

According to a second embodiment, each male roller 5 is directly supported by a support lever 20, while the female rollers 6 are indirectly supported by the support levers 20 through the male rollers 5.

In detail, while each male roller 5 is rotatably mounted on a respective support lever 20 so that it can rotate about its symmetry axis, the female rollers 6 are supported by the adjacent male rollers 5 due to the engagement between end 8 and cavity 7 and are driven in rotation by said male rollers 5 around their symmetry axis.

To keep the position of each female roller 6 centred relative to that of the adjacent male rollers 5 and therefore prevent the female roller 6 from falling during radial expansion of the presser element 3, centring elements 9 are present.

In particular, each centring element 9 comprises a half-lever 33 in engagement with a female roller 6 so as to ensure free rotation of the female roller 6, and two pairs of arms 19, 19′.

Each pair of arms 19, 19′ is hinged at a single common point 27 on a support lever 20 and at two distinct points 28 on a half-lever 33 so as to form a quadrilateral when the presser element 3 is expanded.

As viewed in more detail from FIG. 5, both the male rollers 5 and female rollers 6 have an outward swelling outline so as to ensure the greatest contact continuity between the rollers 5, 6 and the sides 34 of the toroidal support element 13 during the step of turning up the end portions 14 of the strip-like elements 15.

Shown in FIGS. 6a-6d are some steps of a tyre building method comprising a carcass structure including at least one carcass ply 2, 2′ and at least one annular reinforcing structure associated with the carcass ply. The carcass structure has at least one bead core 10, a tread band at a position radially external to the carcass structure, ad a pair of sidewalls at axially opposite positions on the carcass structure. Manufacture of said carcass structure involves laying of a plurality of strip-like elements 15 on a toroidal support 13.

In accordance with the invention, during manufacture of said carcass ply 2 grip members of the type described in the European Patent Application issued under No. 0 928 680, dispose each strip-like element 15 on the toroidal support 13 in a substantially U-shaped conformation around the cross-section outline of said toroidal support so as to define a crown portion extending at a radially external position on the toroidal support 13 and two side portions spaced apart from each other in an axial direction.

The strip-like elements 15 are disposed side by side with respect to each other along the circumferential extension of the toroidal support 13; said arrangement can be carried out by a rotation of the toroidal support 13 due to a continuous approaching of each strip-like element 15 with respect to the preceding one.

The laying step is generally repeated until at least one carcass ply 2 has been completed.

At this point at least one annular reinforcing structure 10 is applied to the side portions of the strip-like elements so that the annular reinforcing structure 10 is located at a radially more external position than the end portions 14.

An annularly continuous presser element 3 is then brought into contact with the axially internal surfaces of the end portions 14 (FIG. 6a). In detail, each contact element 18 forming the presser element 3 contacts the axially internal surface of at least one end 14, as shown in FIG. 6a.

The annularly continuous presser element 3, in contact with the axially internal surface of the ends 14 is then axially translated from the inside to the outside of the toroidal support 13 and radially still from the inside to the outside of the toroidal support 13, so as to follow the outline of the toroidal support 13 to turn up the end portions 14 around the annular reinforcing structure 10.

It is to be noted that each strip-like element 15 is obtained prior to said laying step through a cutting step starting from a continuous ribbon-like element.

During the turning-up step, the presser element 3 consisting of the assembly of contact elements 18, exerts a contact pressure in a uniform manner, i.e. identical in absolute value, on the end portions 14 and in a continuous manner over the whole circumferential extension thereof. In this way, all the strip-like elements 1S to be turned up and turned up homogeneously are caught simultaneously.

In addition, to avoid tears on the strip-like elements 15, during this step the presser element 3 runs at least partly on the axially internal surfaces of the end portions 14. In other words, the rollers 5 and 6 can revolve on themselves to convert the possible sliding friction into rolling friction.

Shown in FIG. 7 is a detail of a first embodiment of a carcass structure comprising a carcass ply 2 made following the method of the present invention, in which the strip-like elements 15 have their end portions 14 turned up around the annular reinforcing structures 10. More specifically, each annular reinforcing structure 10 comprises a pack of radially superposed coils made of a (preferably metallic) thread. Alternatively, each annular reinforcing structure 10 can consist of a plurality of wire coils that are radially superposed and in axial side by side relationship.

The pack of coils can be obtained by winding up on said building support, a plurality of coils that are radially superposed and possibly disposed in axial side by side relationship, said coils consisting of a wire or, alternatively, a cord of wires, a ribbon of said wires or cords or even a metal strap.

Alternatively, each pack of coils can be obtained separately and subsequently applied to the toroidal support 13.

The material used for the annular reinforcing structures 10 can be any textile or metallic material, or a material of other nature provided with suitable features of mechanical strength. Preferably, this material is steel wire commonly used in the tyre technology, or a metallic cord provided with a corresponding strength and carrying capacity.

A further embodiment of carcass structure, not shown, involves a first carcass ply 2, formed with strip-like elements 15 and a second carcass ply 21, still consisting of strip-like elements 15, both associated with the same bead core 10.

In this case too, the annular reinforcing structure 10 is made up of a plurality of wire coils that are radially superposed and possibly disposed in axial side by side relationship.

For manufacturing such a carcass structure, after laying a second plurality of strip-like elements 15 on the first ply 2, so as to form a second carcass ply 2′, the annularly continuous presser member 3 is brought again into contact with the axially internal surfaces of the end portions 14 of the ply 2 to carry out turning up of said portions, together with those of the second ply 2′, around the annular reinforcing structure 10.

The turning-up step takes place in the manner already described in connection with the preceding embodiment.

1-27. (canceled)

28. A process for building a pneumatic tyre, which comprises: a carcass structure comprising at least one carcass ply; at least one annular reinforcing structure associated with said carcass structure close to a radially internal edge of the carcass structure; a tread band at a radially external position to said carcass structure; and a pair of sidewalls on said carcass structure at axially opposite positions; comprising the steps of:
a) laying a plurality of strip-like elements on a toroidal support, each strip-like element comprising at least one reinforcing element coated with at least one layer of elastomeric material and being laid in a substantially U-shaped conformation around the cross-section outline of said toroidal support to define a crown portion extending on said toroidal support in a radially external position and two side portions spaced apart from each other in an axial direction, the side portions of at least one strip-like element comprising end portions radially projecting toward the central axis of said toroidal support;
b) applying said at least one annular reinforcing structure close to said side portions, each annular reinforcing structure being applied at a radially more external position relative to said end portions;
c) bringing an annularly continuous presser element into contact with axially internal surfaces of the end portions; and
d) axially and radially translating said annularly continuous presser element to fold said end portions around said at least one reinforcing element.

29. The process as claimed in claim 28, wherein during the translation step, said presser element exerts a uniformly distributed contact pressure on said end portions.

30. The process as claimed in claim 28, wherein said at least one annular reinforcing structure is obtained by a step of winding up a plurality of radially superposed wire coils on said toroidal support.

31. The process as claimed in claim 28, wherein said at least one annular reinforcing structure is obtained by a step of winding up a plurality of wire coils on said toroidal support, said coils being disposed radially superposed and in axial side by side relationship with respect to each other.

32. The process as claimed in claim 28, wherein step a) is repeated until a carcass ply has been completed.

33. The process as claimed in claim 28, wherein step a) is repeated until two superposed carcass plies have been completed.

34. The process as claimed in claim 28, wherein during the turning-up step, said presser element runs on the axially internal surfaces of said end portions.

35. The process as claimed in claim 28, wherein said strip-like element is obtained by a cutting step carried out on a continuous ribbon-like element.

36. An apparatus for building a pneumatic tyre, comprising toroidal support; at least one device for laying a plurality of strip-like elements on said toroidal support; at least one device for applying at least one annular reinforcing structure close to an inner radial edge of said toroidal support and at least one turning-up device comprising an annularly continuous presser element coaxial with a central axis of the toroidal support and radially expandable relative to the central axis of said toroidal support to contact axially inner surfaces of said strip-like elements and turn said axially inner surfaces up around said at least one annular reinforcing structure.

37. The apparatus as claimed in claim 36, wherein said annularly continuous presser element is radially expandable and contractible relative to the central axis of said support to contact the axially inner surfaces of said strip-like elements and turn said axially inner surfaces up around said at least one annular reinforcing structure.

38. The apparatus as claimed in claim 36, wherein said annularly continuous presser element comprises a plurality of contact elements disposed along a circumference that is concentric to the central axis of said toroidal support, and a plurality of centres of rotation each operationally associated with a contact element to enable each contact element to rotate relative to a respective centre of rotation in a continuous manner, to radially expand or contract said presser element between a radially contracted position and an expanded position at which said contact elements are disposed close to the sides of said toroidal support, each contact element defining a continuous circumferential surface with adjoining contact elements irrespective of the radially expanded or contracted position of said presser element.

39. The apparatus as claimed in claim 38, wherein said turning-up device comprises means for adjusting the contracted position of said annular element depending on the size of the tyre to be manufactured.

40. The apparatus as claimed in claim 38, wherein, in said radially contracted position, said contact elements are disposed axially internal to said toroidal support element.

41. The apparatus as claimed in claim 38, wherein each contact element is circumferentially telescopically slidable relative to an adjoining contact element.

42. The apparatus as claimed in claim 38, wherein said plurality of contact elements comprises a first set of male rollers comprising two axially opposite head ends and a set of female rollers comprising two axially opposite cavities, said male and female rollers being disposed in such a manner that each male roller is followed by a female roller, each end of a male roller being engaged in a cavity of a female roller so as to form a closed loop.

43. The apparatus as claimed in claim 38, wherein a plurality of support levers for said contact elements is provided, said levers being disposed around a circumference concentric to the central axis of said toroidal support, each lever being hinged on one said centre of rotation.

44. The apparatus as claimed in claim 38, wherein each male roller is supported by one said support lever.

45. The apparatus as claimed in claim 44, wherein each male roller is rotatably mounted on a respective support lever so that said male roller can rotate around a symmetry axis of said male roller.

46. The apparatus as claimed in claim 42, wherein each female roller is supported by one support lever.

47. The apparatus as claimed in claim 46, wherein each female roller is rotatably mounted on a support lever so that said female roller can rotate about a symmetry axis of said female roller.

48. The apparatus as claimed in claim 42, wherein each female roller is supported by two adjacent male rollers and is driven in rotation by said male rollers.

49. The apparatus as claimed in claim 42, wherein each female roller is maintained at a relative position with respect to two adjacent male rollers by a centring element irrespective of a radially expanded or contracted position of the presser element.

50. The apparatus as claimed in claim 49, wherein each centring element is supported and held in a correct position by at least two pairs of arms hinged on two adjacent support levers, respectively.

51. The apparatus as claimed in claim 42, wherein each contact element comprises an outward swelling outer outline to ensure a contact continuity between the male and female rollers and sides of the toroidal support element during the step of turning up said strip-like elements.

52. The apparatus as claimed in claim 43, wherein all centres of rotation of said support levers are supported by a guide that is axially slidable relative to the axis of said toroidal support element.

53. The apparatus as claimed in claim 43, wherein each lever comprises one end hinged on a second guide element that is axially translatable relative to a first guide element to determine radial expansion or contraction of said presser element.

54. The apparatus as claimed in claim 43, wherein each support lever comprises a main body and an end supporting the contact element, said end being disposed inclined to said main body to allow the contact element to contact an axially internal surface of the strip-like elements forming the carcass ply when said presser element is at a radially contracted position.
